(19) United States
(12) Patent Application Publication
(10) Pub. No.: US 2026/0336700 A1
(43) Pub. Date: Oct. 29, 2026

(54) COMPONENTS FOR A VEHICLE AND METHODS

(71) Applicant: AUTOTECH ENGINEERING S.L., Amorebieta-Etxano (ES)

(72) Inventors: Sergi MARQUEZ DURAN, Rajadell, Barcelona (ES); Marti MECA MARTÍNEZ, Santpedor, Barcelona (ES); Javier VALENCIA CARRIÓ, Manresa, Barcelona (ES)

(21) Appl. No.: 19/109,103

(22) PCT Filed: Sep. 21, 2023
(86) PCT No.: PCT/EP2023/076068

§ 371 Date: Mar. 5, 2025

(30) Foreign Application Priority Data
Sep. 21, 2022 (EP) 22382870.8

(51) Int. Cl. B62D 21/02; B60K 1/04; B62D 21/07; C21D 8/00

(52) U.S. Cl. CPC B62D 21/02; B60K 1/04; B62D 21/07; C21D 8/00

(57) ABSTRACT

The present disclosure relates to a component for a vehicle framework comprising a main frame extending from a fore end to an aft end along a longitudinal direction of the vehicle framework. The main frame substantially defines a closed ring shape and comprises a first and a second side members and a first and a second cross-members. Further, the main frame is made by deforming a single blank. The present disclosure further relates to methods for manufacturing such components.

The present application claims the benefit of European patent application n° 22 382 870.8 filed on Sept. 21, 2022.

The present disclosure relates to components for a vehicle framework, the components comprising a main frame that substantially defines a ring shape. The present disclosure further relates to methods for manufacturing such components.

### BACKGROUND

Vehicles such as cars incorporate a structural skeleton designed to withstand the loads that the vehicle may be subjected to during its lifetime. The structural skeleton is further designed to withstand and absorb impacts, in case of e.g. collisions with other cars or road structures.

The trend towards manufacturing low emission and more efficient vehicles has increased dramatically over the last decades. The rapid development of hybrid and electric vehicles has forced the industry to design new car components, i.e. for weight reduction to achieve improved vehicle range, and for accommodating and protecting new car components among others.

The demand for weight reduction in the automotive industry has led to the development and implementation of lightweight materials or components, and related manufacturing processes and tools. The demand for weight reduction is especially driven by the goal of a reduction of CO2 emissions. The growing concern for occupant safety also leads to the adoption of materials which improve the integrity of the vehicle during a crash while also improving the energy absorption.

A process known as Hot Forming Die Quenching (HFDQ) typically uses boron steel sheets to create stamped components with Ultra High Strength Steel (UHSS) properties, with tensile strengths of e.g. 1.500 MPa or 2.000 MPa or even more. The increase in strength allows for a thinner gauge material to be used, which results in weight savings over conventionally cold stamped mild steel components. Throughout the present disclosure UHSS may be regarded as a steel having an ultimate tensile strength of 1.000 MPa or more after a press hardening process.

In a HFDQ process, a blank to be hot formed may be heated to a predetermined temperature e.g. austenization temperature or higher (and particularly between Ac3 and an evaporation temperature of e.g. a coating of the blank). A furnace system may be used for this purpose. Depending on the specific needs, a furnace system may be complemented with additional heaters, e.g. induction heaters or infrared heaters. By heating the blank, the strength of the blank decreases and deformability increases i.e. to facilitate the hot stamping process.

There are several known Ultra High Strength steels (UHSS) for hot stamping and hardening. The blank may be made e.g. of a boron steel, coated or uncoated, such as Usibor® (22MnB5) commercially available from ArcelorMittal.

Hot Forming Die Quenching may also be called “press hardening” or “hot stamping”. These terms will be used interchangeably throughout the present disclosure.

Hot forming of boron steels is becoming increasingly popular in the automotive industry due to their excellent strength and formability. Many structural components that were traditionally cold formed from mild steel are thus being replaced with hot formed equivalents that offer a significant increase in strength. This allows for reductions in material thickness (and thus weight) while maintaining the same strength. However, hot formed components may offer low levels of ductility and energy absorption in the as-formed condition.

In order to improve the ductility and energy absorption in specific areas of a component, it is known to introduce softer regions within the same component. This improves ductility locally while maintaining the required high strength overall. By locally tailoring the microstructure and mechanical properties of certain structural components such that they comprise regions with very high strength (very hard), i.e. high ultimate tensile strength and high yield strength and regions with increased ductility (softer), i.e. lower ultimate tensile strength and lower yield strength and increased elongation before break, it may be possible to improve their overall energy absorption and maintain their structural integrity during a crash situation and also reduce their overall weight. Such soft zones may also advantageously change the kinematic behavior in case of a collapse of a component under an impact.

Known methods of creating regions with increased ductility (“softzones” or “soft zones”) in structural components of vehicles include the provision of tools comprising a pair of complementary upper and lower die units, each of the units having separate die elements (steel blocks). A blank to be hot formed is previously heated to a predetermined temperature e.g. austenization temperature or higher by, for example, a furnace system so as to decrease the strength i.e. to facilitate the hot stamping process.

The die elements may be designed to work at different temperatures, in order to have different cooling rates in different zones of the part being formed during the quenching process, and thereby resulting in different material properties in the final product e.g. soft areas which will generally have a lower ultimate tensile strength and a lower yield strength, but allow for more elongation before breaking. E.g. one die element may be cooled in order to quench the corresponding area of the component being manufactured at high cooling rates and to thereby reduce the temperature of the component rapidly and obtain a hard martensitic microstructure. Another neighboring die element may be heated in order to ensure that the corresponding portion of the component being manufactured cools down at a lower cooling rate, in order to obtain a softer microstructure, including e.g. bainite, ferrite and/or perlite. Such an area of the component may remain at higher temperatures than the rest of the component when it leaves the die.

Other methods for obtaining hot stamped components with areas of different mechanical properties include e.g. tailored or differentiated heating prior to stamping, and local heat treatments after a stamping process to change the local microstructure and obtain different mechanical properties. Yet further possibilities include the use of patchwork blanks, and Tailor Welded Blanks (TWB) combining different thicknesses and/or materials in blanks.

In addition to the Ultra High Strength Steels mentioned before, more ductile steels may be used in parts of the structural skeleton requiring energy absorption. Examples of ductile steels include Ductibor® 500, Ductibor ® 1000 and CRL-340LA.

UHSS may exhibit tensile strengths as high as 1.500 MPa, or even 2.000 MPa or more, particularly after a press hardening operation. Once hardened, a UHSS may have a martensitic microstructure. This microstructure enables an increased maximum tensile and yield strength per weight unit.

Some ductile steels may also be heated and pressed (i.e. used in a hot stamping process), but will not have a martensitic microstructure after the process. As a result, they will have lower tensile and yield strength than UHSS, but they will have a higher elongation at break.

Although ductile steel enables energy absorption by a structural component, controlling and predicting how the structural component may behave during a vehicle crash may not be easy. Moreover, the overall weight of the vehicle framework is preferably as low as possible to reduce fuel consumption. Also, enhancing energy absorption while maintaining a certain structural integrity of the structural component is not straightforward.

Car manufacturers are also increasingly using composite materials to try to further reduce weight.

In hybrid and electric vehicles, the introduction of a relatively large battery assembly has generated the need for modification of several structural components, i.e. structural components in relation with the newly introduced battery assemblies. These structural components should be designed such that the battery assemblies can be accommodated, and also protected from vehicle collisions and other external impacts, i.e. underfloor impacts. These structural components may be manufactured in a variety of ways and may be made of a variety of materials. Lightweight materials that improve the energy absorption during a crash while also keeping the integrity of the vehicle are desired.

The present disclosure aims to provide improvements in the integration of traction batteries into a structural skeleton of a car.

### SUMMARY

In a first aspect, a component for a vehicle framework is provided. The component comprises a main frame extending from a fore end to an aft end along a longitudinal direction of the vehicle framework. The main frame substantially defines a closed ring shape, and comprises a first and a second side member, and a first and a second cross-member. The main frame is formed by deforming a single blank.

In accordance with this aspect, a component with a simplified manufacturing process is provided. Since the main frame is manufactured by deforming a single blank, the manufacturing time and associated costs may be reduced. Further, other manufacturing post-processes such as welding, which may affect the mechanical properties of the component, are avoided. At the same time, the component provided can have sufficient strength and stiffness, and energy absorption to provide protection to a central free space of the ring shape in the case of impact. The fore end and the aft end of the main frame can absorb energy in a frontal or rear impact, whereas the side members of the main frame can absorb energy in a side impact. The ring shaped main frame is generally designed to transfer the impact loads towards suitable areas of the vehicle framework. Thus, the main frame can reduce the accelerations in the car due to collisions. Further, the component may improve protection of other vehicle components located inside the ring shape, e.g. a battery assembly. Further, the main frame can prevent deformation in the safety zone inside the vehicle so as to enhance passenger safety.

Further, the component according to this aspect can provide a reduction in the vehicle's weight compared to existing counterpart components. This has a direct effect on the efficiency of the vehicle, i.e. higher battery autonomy.

Throughout the present disclosure, “ring shape” may be understood as a closed shape with a central free space. This closed shape may define a substantially rectangular periphery, a square periphery or a substantially oval periphery among others. Similarly, the central free space may define any suitable shape.

Also, throughout the present disclosure, references to the “mechanical properties of a portion” may be understood as the mechanical properties of the material forming said portion. Therefore, unless otherwise stated, comparisons of mechanical properties of portions, components, or others, are directed to the material and not to the geometry, or other particularities, of the same.

Throughout the present disclosure a blank may be regarded as a metal sheet or thin metal plate that is to be formed into an end product or semi-finished product. The blank that is to be formed into the main frame may in particular be a combined blank, composed of several blanks or “sub-blanks”, of the same or different materials and/or thicknesses.

A sub-blank, a plurality of sub-blanks or all sub-blanks may be made of hardenable steel, specifically boron steel. A thickness of the blank may be typically between 0.8 and 3 mm.

A patch may be regarded as a blank that will form a local patch on the main frame of the component. A blank to which a patch has been added is sometimes referred to as a “patchwork blank”. This is to distinguish from “tailor welded blank”, in which at least two sub-blanks are joined to each other through edge to edge welding.

Higher mechanical properties may herein be understood as a higher ultimate tensile strength and/or a higher yield strength, whereas lower mechanical properties may be understood as a lower ultimate tensile strength and/or a lower yield strength. Ultimate tensile strength and yield strength are herein regarded as material properties of the material after the manufacturing process. Ultimate tensile strength and yield strength may be determined in standardized tensile strength tests, using e.g. A30, A50 or A80 specimens in a quasi-static load test.

The comparison between lower and higher mechanical properties should be made using the same test conditions and specimen size. To compare yield strengths of different portions, specimens may be prepared and tested in a Universal Testing Machine (UTM).

In examples, the main frame may be made by hot stamping. Thus, the main frame may have at least some of the benefits of components made by this manufacturing process previously disclosed.

In some examples, the single blank (“combined blank”) that is to be formed into the main frame comprises at least two sub-blanks forming one or more overlapping regions. The overlapping regions may be formed by partially overlapping the two sub-blanks. In some examples, at least one of the overlapping regions is located in a portion of the main frame configured to be connected to other components of the vehicle framework i.e. the overlap is arranged in an area of the combined blank such that after deforming it is arranged in a suitable part of the main frame. The mechanical strength and stiffness of an overlapping region may be higher than the remainder of the main frame due to the increased thickness where the sub-blanks overlap. Providing the overlapping region in an area used for joining to other parts of the vehicle framework promotes a robust connection between components, i.e. when the connection is configured to transmit loads between components.

In further examples, overlapping regions may be formed at transitions between the side members and the rear cross-member.

Further, using appropriate materials, suitable properties in terms of crash behaviour and reduced weight can be conferred to the main frame by e.g. using patch welding. For instance, welding a first patch to the main frame reinforces the main frame where necessary without adding additional undesired weight.

In examples, the patchwork blank may have overlapping soft (or “ductile”) and hard materials in areas conceived to withstand compressive or bending forces in case of a crash situation. In these areas, the component can withstand more deformation (e.g. higher bending angles) without the risk of rupture and can make the vehicle safer.

Usually, patches are welded to the main piece by spot welding, which is a well-known and broadly used welding technology in the automotive field. Overlapping sub-blanks may also be connected by spot welding.

In examples, the single blank may comprise a tailor welded blank comprising at least two sub-blanks with different thicknesses or different materials. In some examples, one or more of the sub-blanks that together form the combined blank may be a tailor welded blank. Sub-blanks may comprise materials with different mechanical properties to tailor the strength, stiffness and deformation properties of the main frame.

In examples, at least a portion of the main frame, i.e. a side member and/or a cross-member, may be made of a steel having an ultimate tensile strength above 1500 MPa after a press-hardening process.

In some examples, at least a portion of the main frame may have a substantially U-shaped cross-section. The U-shaped cross-section has a bottom wall a first side wall, a second side wall, a first lateral flange projecting outwardly at an end of the first side wall and a second lateral flange projecting outwardly at an end of second side wall. The portion having a U-shaped cross-section may be a part of a member, i.e. a part of a cross-member, or a portion extending along several members.

The U-shaped cross-section provides stiffness to the main frame, it is easy to manufacture and provides convenient regions, i.e. the flanges, to connect with other structural elements. Throughout the present disclosure, a U-shaped cross-section may be understood as relating to a structural member which in a cross-section (generally in a transverse plane which is substantially perpendicular to a longitudinal axis of the structural member) has a bottom wall and two side walls. The U-shaped cross-section is generally known for having a good ratio of moment of inertia to weight. The two side walls may form an obtuse angle with the bottom wall, e.g. between 90° and 135°. The two side walls may include outwardly extending side flanges. The bottom wall and side walls may be substantially straight, but they may also include transitions, curved portions, recesses or protrusions.

In examples, the main frame may be configured for receiving a battery assembly in a central free space of the ring shape. Further, in some examples, the side members comprise a central region between the fore end and the aft end configured to be connected to the battery assembly. Thus, the main frame may provide support and protection to the battery assembly of the vehicle.

In examples, the side members are configured to be connected to a front rail and a rear rail of the vehicle framework at the fore end and the aft end, respectively.

In some examples, each side member is configured to be connected to a lateral rocker of the vehicle framework. The connection may be performed horizontally, i.e. the side member and the lateral rocker may be one next to the other in a horizontal direction, or vertically, i.e. the side member may be substantially on top of the rocker, or vice versa.

The component of the present disclosure may be part of a vehicle framework i.e. it may be part of the body-in-white of the vehicle.

In examples, a battery assembly (battery box or tray, battery cells, cover etc.) may be connected to the component. The connection between the battery assembly and the main frame of the component may be performed after joining the component to the rest of the vehicle framework. The connection between the battery assembly may be direct i.e. using fastener assemblies or using intermediate components.

In a further aspect, a method for manufacturing a component for a vehicle framework is provided. The component comprises a main frame substantially defining a closed ring shape, and the main frame comprises a first and a second side members and a first and a second cross-members.

The method comprises providing a single blank. The method further comprises heating the single blank above an Ac3 austenization temperature, and press hardening the heated single blank forming the component.

This method provides a simpler and yet more efficient manner of manufacturing a component compared to known approaches. Further, the resulting component may have a reduced weight compared with components of similar mechanical properties manufactured using other methods. Additionally, the resulting component may have an improved deformation behavior, and the method may enable adjusting how the component deforms during e.g. a car crash. Thus, energy absorption and overall vehicle safety may be enhanced.

In some examples of the method, the single blank comprises at least two sub-blanks, and the method further comprises joining the sub-blanks to each other. The joining step may include forming one or more overlapping regions by partially overlapping two sub-blanks.

### BRIEF DESCRIPTION OF THE DRAWINGS

Non-limiting examples of the present disclosure will be described in the following, with reference to the appended figures, in which:

FIG. 1 schematically illustrates a perspective top view of an example of a component for a vehicle.

FIG. 2 schematically illustrates a top view of the component in FIG. 1.

FIG. 3 schematically illustrates a side view of the component in FIG. 1.

FIG. 4 schematically illustrates a perspective top view of another example of a component for a vehicle.

FIG. 5 schematically illustrates a cross-section of the component across the plane A-A in FIG. 4.

FIG. 6 schematically illustrates another example of a component in a vehicle framework.

FIG. 7 schematically illustrates a single blank prior to forming another example of a component.

FIG. 8 is a flow chart of a method for manufacturing a component.

The figures refer to example implementations and are only be used as an aid for understanding the claimed subject matter, not for limiting it in any sense.

### DETAILED DESCRIPTION OF EXAMPLES

FIG. 1 schematically illustrates a perspective top view of an example of a component for a vehicle framework. The component comprises a main frame 100 that extends from a fore end 200 to an aft end 300 along a longitudinal direction of the vehicle framework. The main frame substantially defines a closed ring shape and comprises a first side member 110, a second side member 120, a first cross-member 130 and a second cross-member 140. Further, the main frame 100 is made by deforming a single blank.

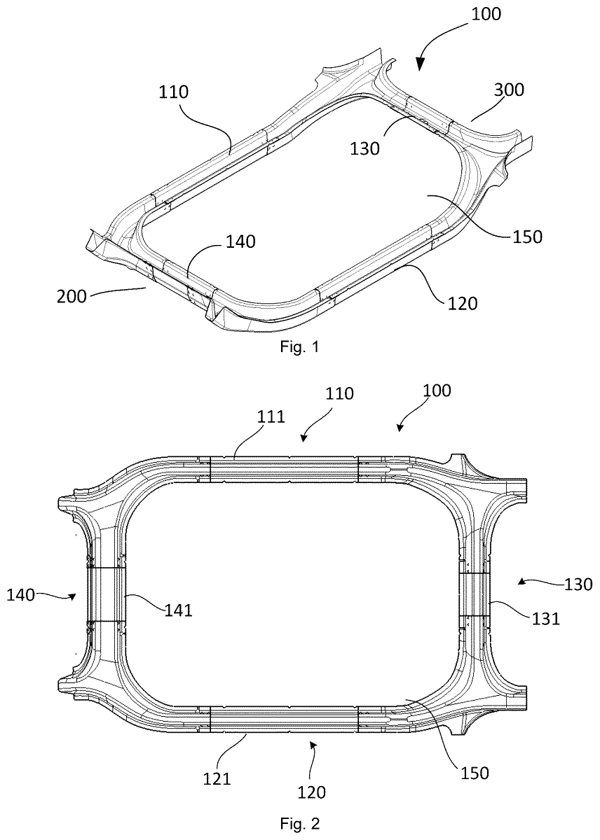

As may be seen in e.g. FIGS. 1 and 2, the first and second side members 110, 120 generally extend along the longitudinal direction of the vehicle framework. The first and second cross-members generally extend in a transverse direction, i.e. substantially horizontally and substantially perpendicular to the longitudinal direction of the vehicle framework.

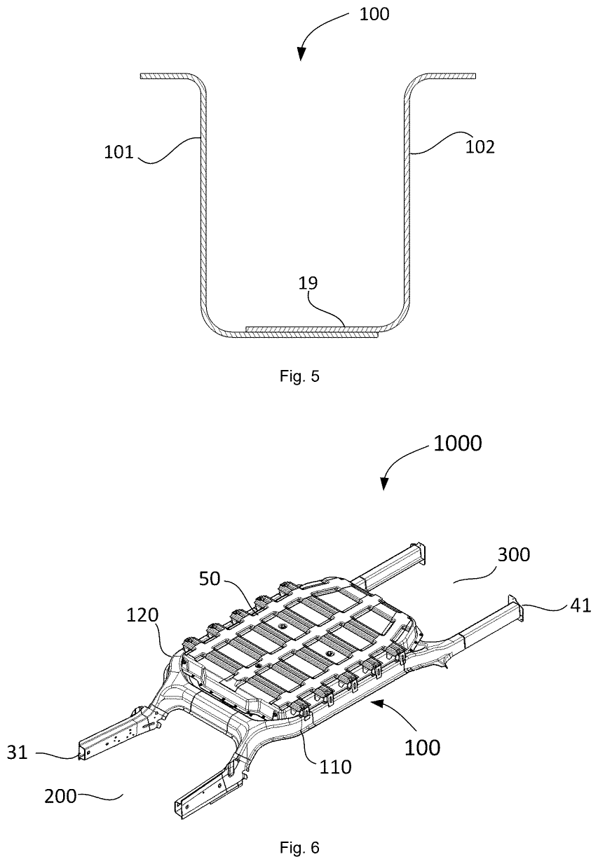

The example of the main frame 100 illustrated in FIG. 1 may be manufactured by hot stamping. For example, it may be made in a direct hot stamping manufacturing process or in an indirect hot stamping manufacturing process. In other examples, the main frame 100 may be manufactured by cold stamping or by other manufacturing process. Further details on the manufacturing process of a component will be described in relation to FIG. 5.

The main frame 100 of the component may have at least a portion with a substantially U-shaped cross-section. The U-shape cross-section may have a bottom wall, a first side wall, a second side wall, a first lateral flange projecting outwardly at an end of the first side wall and a second lateral flange projecting outwardly at an end of second side wall. The lateral flanges provide a convenient attachment point for e.g. riveting or spot welding to connect the main frame 100 with other parts of the vehicle, e.g. other components of the structural framework of the vehicle. Once mounted in the vehicle framework, the U-shape may be substantially directed upwards i.e. the bottom wall is at the bottom and the open side of the U is at the top.

Further, the bottom wall may be substantially perpendicular to the side walls. In further examples, the bottom wall may define an angle different than 90 degrees with respect to the side walls. The radius of curvature between the bottom wall and the side walls may be adapted according to the specifications of the main frame 100, i.e. mechanical properties of the material used, maximum local strength desired and others. The radius of curvature between the side walls and the lateral flanges may also vary according to the specifications of the main frame 100, as previously discussed.

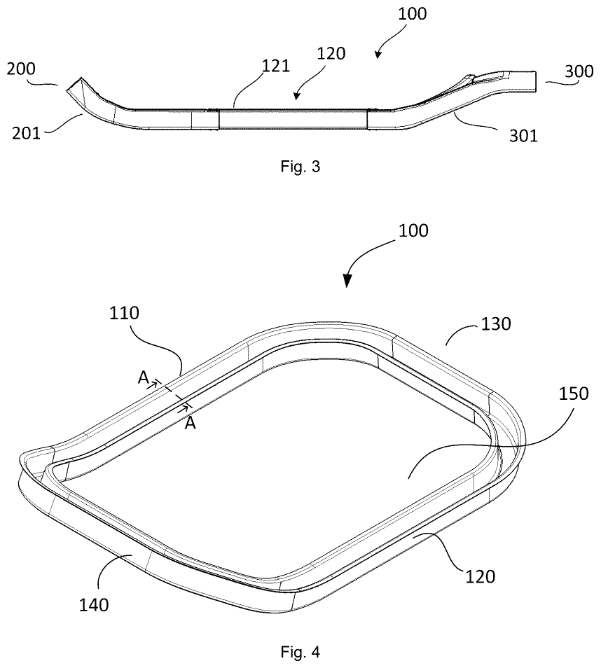

FIGS. 2 and 3 show a top view and a side view of the example component of FIG. 1, respectively. These figures illustrate that the main frame 100 may be configured for receiving a battery assembly in a central free space 150 of the ring shape.

Further, in some examples, the main frame 100 may comprise side members 110, 120 with a central region 111, 121 between the fore end 200 and the aft end 300 configured to be connected to a battery assembly (not illustrated). The battery tray or battery box may be connected to the main frame 100 through one or more brackets. E.g. the battery assembly may be connected to each of the side members with two brackets.

The main frame 100 of the component may also comprise one or more soft zones (not illustrated) having lower mechanical properties than other zones of the main frame 100. The soft zone(s) may cover certain regions of the main frame 100 so as to absorb energy in case of an impact, and to limit the extent of intrusion in other zones of the main frame 100. Thus, to improve battery and occupant safety, a component with different mechanical properties at different locations in the main frame 100 may be provided.

In some examples, an outer side wall of the side members may include a soft zone to be able to absorb energy in a side crash and protect the battery assembly.

In a specific example, portions of the main frame that are joined to the rear rails may be more ductile than other parts. In some examples, the soft zone may extend along a portion of the side members, e.g. along 5-20% of a length of the side members.

The soft zone may have a yield strength of between 600-950 MPa, specifically between 650-800 MPa. Further, the main frame 100 of the component may have an ultimate tensile strength (outside the soft zone(s)) of predominantly 1.000 MPa or more, specifically 1.200 MPa or more, and more specifically 1.500 MPa or more.

The main frame 100 may have a transition zone, i.e. between the soft zone and the remainder of the main frame 100 with a width smaller than 30 mm, specifically between 20 and 5 mm.

In some examples, the main frame 100 may be made of a boron steel like Usibor®, e.g. Usibor® 1500 (22MnB5 steel with or without protective coating), Usibor® 2000(37MnB5 ) or any martensitic steel or ultra high strength steel (UHSS). Usibor®, is commercially available from ArcelorMittal.

Usibor® 1500 is supplied in ferritic-perlitic phase. It is a fine grain structure distributed in a homogenous pattern. Its mechanical properties are related to this structure. After heating, a hot stamping process and subsequent quenching, a martensite microstructure is created. As a result, tensile strength and yield strength increase noticeably.

The composition of Usibor® 1500 is summarized below in weight percentages (the rest is iron (Fe) and impurities):
Maximum carbon (C) (%): 0.25
Maximum silicon (Si) (%): 0.4
Maximum manganese (Mn) (%): 1.4
Maximum phosphorus (P) (%): 0.03
Maximum sulphur(S) (%): 0.01
Aluminium (AI) (%): 0.01-0.1
Maximum titanium (Ti) (%): 0.05
Maximum niobium (Nb) (%): 0.01
Maximum copper (Cu) (%): 0.20
Maximum boron (B) (%): 0.005
Maximum chromium (Cr) (%): 0.35

Usibor® 2000 is another boron steel 37MnB 5 with even higher strength. After a hot stamping die quenching process, the yield strength of Usibor® 2000 may be 1300 MPa or more, and its ultimate tensile strength may be above 1800 MPa.

The composition of Usibor® 2000 is summarized below in weight percentages (rest is iron (Fe) and impurities):
Maximum carbon (C) (%): 0.36
Maximum silicon (Si) (%): 0.8
Maximum manganese (Mn) (%): 0.8
Maximum phosphorus (P) (%): 0.03
Maximum sulphur(S) (%): 0.01
Aluminium (AI) (%): 0.01-0.06
Maximum titanium (Ti) (%): 0.07
Maximum niobium (Nb) (%): 0.07
Maximum copper (Cu) (%): 0.20
Maximum boron (B) (%): 0.005
Maximum chromium (Cr) (%): 0.50
Maximum molybdenum (Mb) (%): 0.50

22MnB5 and other boron steels may be presented with an aluminum-silicon coating in order to avoid decarburization and scale formation during the forming process. Several 22MnB5 steels are commercially available having a similar chemical composition. However, the exact amount of each of the components in a 22MnB5 steel may vary slightly from one manufacturer to another. Other ultra high strength steels include e.g. BTR 165, commercially available from Benteler.

In examples, the main frame 100 may comprise members made of different materials. For example, the main frame 100 may comprise side members 110, 120 made of a first UHSS (e.g. Usibor® 1500 or 22MnB5) and a first and second cross-member 130, 140 made of another UHSS (e.g. Usibor® 2000 or 37MnB5). Other materials for each member may be chosen to form a component with a given dynamic response and mechanical properties.

FIG. 3 shows that the fore end 200 and aft end 300 of the main frame 100 of the component may be at different heights relative to a central region 121 of the side members 120. Therefore, the main frame 100 may comprise a fore transition region 201 and an aft transition region 301 to provide this transition in height between different regions of the main frame 100. In the illustrated figure, the fore transition region 201 shows a steeper transition than the aft transition region 301. However, in other examples this feature may be reversed. The radius of curvature of these transition regions 201, 301 may be adapted so that the distribution of stresses in case of an impact is tailored.

FIGS. 4 and 5 illustrate another example of a component according to the present disclosure. FIG. 4 is a perspective view of the main frame 100 of the component and FIG. 5 illustrates a cross-section of the component across the plane A-A in FIG. 4.

In the example illustrated in FIGS. 4 and 5, the main frame 100 may comprise by two or more sub-blanks 101, 102 that when formed obtain a substantially L-shaped cross-section. Further, the two sub-blanks 101, 102 together may define a substantially U-shaped cross-section, as can be better seen in FIG. 5. Thus, the two or more sub-blanks 101, 102 may define an overlapping region 19 at a base of the U-shaped cross-section. It should be clear that the sub-blanks 101, 102 are joined to each other when they are both substantially flat plates, i.e. one sub-blank may be positioned to partially overlap the other sub-blank, and then the sub-blanks may be joined e.g. by welding. Once joined to each other (and optionally after joining to yet further sub-blanks), the combined blank may be deformed to obtain the shown ring-shaped member with a U-shaped cross-section.

Each of the two or more sub-blanks 101, 102 may be made of different materials. For example, a sub-blank 101 designed to be located on the outer side of the U-shaped cross-section (with respect to the central free space 150) may be made of an UHSS (e.g. a boron steel like 22MnB5 or similar), and a sub-blank 102 designed to be located on the inner side of the U-shaped cross-section may be made of a more ductile steel (e.g. Ductibor® 1000 or similar).

Ductibor® is a steel material with much higher ductility than Usibor® materials, and components made of this material can be effective for absorbing energy during an impact. The yield strength of Ductibor® 500 may be 400 MPa or more, and the ultimate tensile strength of 550 MPa or more.

The composition of ductibor® 500 is summarized below in weight percentages (rest is iron (Fe) and impurities):
Maximum carbon (C) (%): 0.1
Maximum silicon (Si) (%): 0.5
Maximum manganese (Mn) (%): 1.7
Maximum phosphorus (P) (%): 0.03
Maximum sulphur(S) (%): 0.025
Aluminium (AI) (%): 0.015-0.2
Maximum titanium (Ti) (%): 0.09
Maximum niobium (Nb) (%): 0.10
Maximum copper (Cu) (%): 0.20
Maximum boron (B) (%): 0.001
Maximum chromium (Cr) (%): 0.20

The yield strength of Ductibor® 1000 may be 800 MPa or more, and the ultimate tensile strength of 1000 MPa or more. The composition of Ductibor® 1000 is summarized below in weight percentages (rest is iron (Fe) and impurities):
Maximum carbon (C) (%): 0.10
Maximum silicon (Si) (%): 0.6
Maximum manganese (Mn) (%): 1.8
Maximum phosphorus (P) (%): 0.03
Maximum sulphur(S) (%): 0.01
Aluminium (AI) (%): 0.01-0.1
Maximum titanium (Ti) (%): 0.05
Maximum niobium (Nb) (%): 0.10
Maximum copper (Cu) (%): 0.20
Maximum boron (B) (%): 0.005
Maximum chromium (Cr) (%): 0.20

In examples, the two sub-blanks 101, 102 may be joined by spot welding prior to the forming process.

In the example in FIGS. 4 and 5, the two sub-blanks 101, 102 extend along the perimeter of the entire main frame 100, but in other examples the component may comprise a main frame 100 wherein the sub-blanks do not extend along the whole length of the main frame 100. For example, the main frame 100 may comprise a first cross-member 130 (as cross-member 130 in FIG. 1) formed by overlapping a first blank of Ductibor® with a second blank of Usibor® and defining a U-shaped cross-section. Further, the aforementioned cross-member may be joined to the remainder of the main frame 100 through an additional overlapping region. In addition, the remainder of the main frame 100 may be formed from a single sub-blank or from a plurality of sub-blanks.

FIG. 6 schematically illustrates another example of a component coupled to a vehicle framework 1000 from a bottom isometric perspective. The vehicle framework 1000 illustrated comprises front rails 31, rear rails 41 and the component of the present disclosure comprising the main frame 100. In other examples, the vehicle framework 1000 may further comprise, a floor structure and side structures or other components of the vehicle.

As has been previously disclosed, the main frame 100 may be configured for receiving a battery assembly 50. The battery assembly 50 may be received in the central free space of the ring shape. Further, the side members 110, 120 of the main frame 100 may be configured to be connected to a front rail 31 and a rear rail 41 at the fore end 200 and the aft end 300 of the vehicle framework 1000, respectively. The main frame 100 may be welded to the front and rear rails 31, 41 in some examples.

Additionally, the side members 110, 120 may be configured to be connected to a lateral rocker (not illustrated) of the vehicle framework 1000. Said connection may be performed at different points along the longitudinal direction. In some examples, the connection between the side members 110, 120 and the lateral rockers takes place at a substantially fore and aft location, i.e. in a more central location to the connection with the front rail 31 and rear rail 41 respectively.

Note that the regions of the main frame 100 configured to be connected to other structural elements of the vehicle framework 1000 may have suitable mechanical properties to achieve a secure and firm coupling. These regions may comprise materials with different mechanical properties than the remainder part of the main frame 100, as for example a soft zone or a metallic patch. Also, specific overlapping regions of sub-blanks may be formed in this area to increase the local thickness.

Although not illustrated in FIG. 6, the component may comprise one or more additional members attached to the main frame 100. The additional member may be a cover, a plate or a structural component similar to the main frame 100.

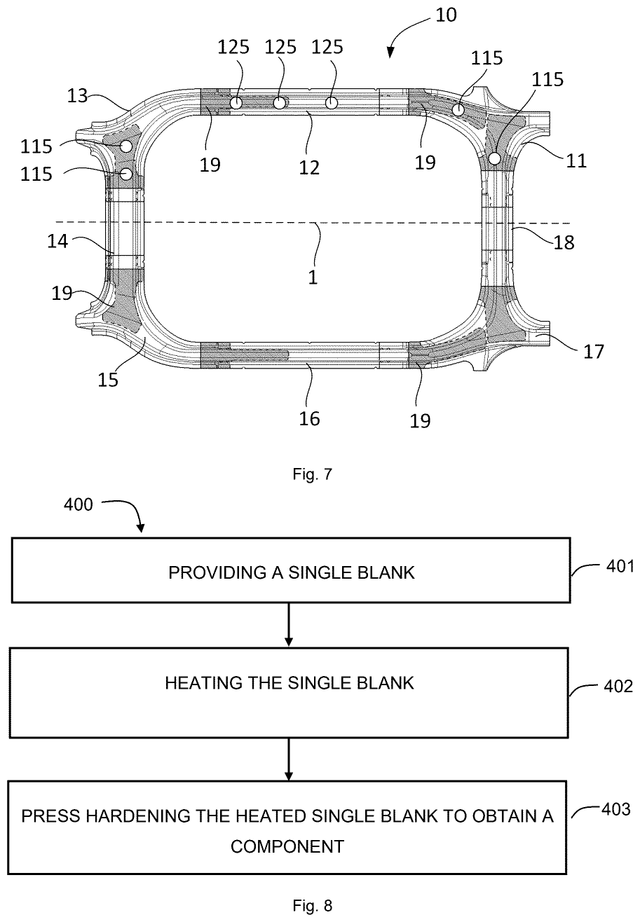

FIG. 7 schematically illustrates a blank 10 prior to forming a ring-shaped main frame according to a further example. The blank 10 may comprise at least two sub-blanks forming one or more overlapping regions formed by partially overlapping the two sub-blanks. In the illustrated example in FIG. 7, the single blank 10 comprises eight sub-blanks 11, 12, 13, 14, 15, 16, 17, 18. In the example, each sub-blank 11, 12, 13, 14, 15, 16, 17, 18 may be formed from the same material, e.g., a boron steel like. Usibor® 2000 or Usibor® 1500, but in other examples sub-blanks may be formed from different materials so that the mechanical properties after forming the main frame, may be substantially different.

Further, in other examples, one or more sub-blanks may be formed from a material with substantially homogenous composition, but it may be subjected to a thermal treatment such that, after forming, the mechanical properties of the respective component are not homogeneous. Thus, a sub-blank may comprise a first portion with higher mechanical properties than a second portion. Further, the first portion may be configured to withstand high impact loads and the second portion may comprise connection points to other components of the main frame 100 or of the vehicle framework.

Further, FIG. 7 shows that the single blank 10 includes a plurality of overlapping regions 19. The overlapping regions 19 may be located where the main frame 100 requires higher mechanical properties to withstand loads acting on the same. The length and shape of the overlapping regions 19 may be designed so that to only cover those locations where higher loads may be present. Additionally, overlapping regions 19 may be designed to cover areas wherein the cross-section transitions from one member to another, e.g. an area between a cross-member and a side member. In the illustrated example in FIG. 7, the overlapping regions 19 represent a transition between side members and cross-members, e.g. a transition between cross-member 14 and side members 15, 13. Further, the overlapping regions 19 may be shaped and dimensioned to improve the overall strength of the main frame 100 (see FIG. 1) but without incurring in excessive weight.

In examples, a first sub-blank may extend onto a second sub-blank by a length of between 2 and 30 cm.

Also by appropriately selecting and providing the overlapping regions 19, internal brackets between the main frame 100 and other components of the vehicle may be removed or reduced.

Additionally, the overlapping regions 19 can improve the stiffness of the connection of the main frame 100 with other components, e.g. with a battery module fixation. In the example in FIG. 7, the side member 12 comprises connection points 125 for battery module fixation that are at least partially located in the overlapping region 19. In addition, the side members 11, 12 comprise connection points 115 for chassis fixation that are at least partially located within the overlapping regions 19.

Further, the overlapping regions 19 may be designed to provide an improved NVH (noise, vibration and harshness) performance, specifically around main frame connection points 115 with the front and the rear chassis.

Note that the connection points 125, 115 have been only illustrated on one side of the single blank 10. The connection points 125, 115 may be arranged symmetrically on the single blank 10 with respect to a central longitudinal axis 1. In other examples, the connection points 125, 115 may not be symmetrical with respect to the central longitudinal axis 1.

In other examples, a patch (not shown) may be included on a sub-blank, i.e. by overlapping the patch to a sub-blank and spot welding. As previously discussed, more than one patch may be welded to the single blank 10 prior to stamping.

Further, at least some of the sub-blanks 11, 12, 13, 14, 15, 16, 17, 18 may have a thickness between 0.8 and 3 mm, specifically between 1 and 2.5 mm.

In examples, other suitable steels may be used, any steel that is suitable for hot or cold stamping. In examples, the blank or sub-blanks may be made of Dual-phase steels (DP steels), e.g. a side member and/or a cross-member. DP steels are high-strength steels with a ferritic-martensitic microstructure that are obtained by quenching the component from a temperature above Ac1 but below Ac3. DP steels comprise a microstructure consisting of a soft ferrite matrix where islands of martensite are contained. Components made of DP steels may have an ultimate tensile strength below 900 MPa, relatively good fatigue resistance, and high strain rate sensitivity, i.e. the faster it is collapsed in case of an impact, the more energy it absorbs.

Further, other steels displaying high formability, possible in combination with high strength may also be used to manufacture (a part of) the main frame 110 by a cold forming process. Members, e.g. a side member and/or a cross-member, made of Fortiform® may provide additional weight reduction compared with components made of DP steels with similar mechanical properties. Fortiform® steels are commercially available from ArcelorMittal.

In some examples, the main frame 110 may be made of Fortiform®, e.g. the main frame 110 may be made of Fortiform® 1180(HF1180Y850 ), which has a tensile strength of 1180-1330 MPa. In other examples, the main frame 110 may be made of Fortiform® S1270, which has a tensile strength of 1270-1400 MPa. In further examples, the main frame 110 may comprise members made of Fortiform® 1180 and members made of Fortiform® S 1270. Further, members of the main frame 110 made of Fortiform® may be welded together using conventional welding processes, e.g. spot welding.

The composition of Fortiform® 1180 is summarized below in weight percentages (rest is iron (Fe) and impurities):
Maximum carbon (C) (%): 0.23
Maximum silicon (Si) (%): 2.0
Maximum manganese (Mn) (%): 2.9
Maximum phosphorus (P) (%): 0.040
Maximum sulphur(S) (%): 0.010
Aluminium (AI) (%): 0.015-1.0
Maximum titanium plus niobium (Ti+Nb) (%): 0.15
Maximum niobium (Nb) (%): 0.10
Maximum copper (Cu) (%): 0.20
Maximum boron (B) (%): 0.005
Maximum chromium plus molybdenum (Cr+Mo) (%): 0.60

The composition of Fortiform® S1270 is summarized below in weight percentages (rest is iron (Fe) and impurities):
Maximum carbon (C) (%): 0.21
Maximum silicon (Si) (%): 1.5
Maximum manganese (Mn) (%): 4.1
Maximum phosphorus (P) (%): 0.04
Maximum sulphur(S) (%): 0.01
Aluminium (AI) (%): 0.015-1.0
Maximum titanium plus niobium (Ti+Nb) (%): 0.15
Maximum niobium (Nb) (%): 0.10
Maximum copper (Cu) (%): 0.2
Maximum chromium plus molybdenum (Cr+Mo) (%): 0.6

Steels suitable for hot forming and for cold forming with other material compositions may be also used to manufacture at least some of the members of the main frame disclosed.

In another aspect of the present disclosure, a method 400 for manufacturing a component for a vehicle framework comprising a main frame 100 is provided. The main frame 100 substantially defines a closed ring shape, and comprises a first and a second side members 110, 120 and a first and a second cross-members 130, 140.

An example of the method 400 is schematically illustrated in FIG. 8. The method 400 comprises, at block 401, providing a single blank 10. The method 400 further comprises, at block 402, heating the single blank 10 at least partially above an Ac3 austenization temperature. Furthermore, the method 400 comprises, at block 403, press hardening the heated single blank 10 forming the component.

In examples, as mentioned before, the single blank 10 may be made of hardenable steel, and a soft zone may be created during forming the component in-die controlled cooling or after forming the component by applying heating.

In some examples, the single blank 10 of method 400 may comprise at least two sub-blanks 11, 12, 13, 14, 15, 16, 17, 18 and the method 400 may further comprise joining the sub-blanks 11, 12, 13, 14, 15, 16, 17, 18 to each other. The step of joining the sub-blanks 11, 12, 13, 14, 15, 16, 17, 18 may include forming one or more overlapping regions 19 by partially overlapping two sub-blanks 11, 12, 13, 14, 15, 16, 17, 18.

In examples, the single blank 10 of method 400 may comprise a tailored welded blank comprising at least two sub-blanks 11, 12, 13, 14, 15, 16.

The single blank 10 may be made of any type of hardenable steel, and particularly boron steel, as has been previously discussed for the main frame 100.

The heating step 402 of method 400 may comprise heating the single blank 10 substantially homogenously above an austenization temperature, and subsequently cooling portions of the single blank 10 particularly below an austenization temperature.

In examples, the single blank 10 may be heated to above Ac3, and portions of the single blank 10 may be cooled to a temperature below Ac3, and even below Ac1 before deforming the blank 10. The other portions may be maintained above Ac3 until the blank 10 is deformed, or may be cooled temporarily but then heated up again to above Ac3.

In some examples, when the blank 10 is positioned in a press tool, different portions of the blank 10 may have different temperatures, whereas temperature within these positions are substantially constant.

Thus, the different temperatures can lead to different microstructures or strength properties being set in the respective portions of the main frame 100, in particular during a subsequent rapid cooling (“quenching”), e.g. in the dies of the press tool.

In examples, the composite blank 10 is shaped during the press hardening step 403 to form a main frame 100 and at the same time is quenched to below 400 °C, or specifically below 300 °C.

In some examples, method 400 may further comprise a step of bake hardening the component 100. During bake hardening, the component may be heating during approximately 20 min between 170 and 200 degrees Celsius, and more specifically at approximately 170 degrees Celsius.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. A vehicle comprising:
a vehicle framework including a rocker, front rails, and rear rails;
a battery assembly; and
a component connected to the battery assembly and connected to one or more of the rocker, the front rails and the rear rails,
the component comprising:
a main frame extending from a fore end to an aft end along a longitudinal direction of the vehicle framework, wherein
the main frame substantially defines a closed ring shape and is configured for receiving the battery assembly in a central free space of the closed ring shape, and wherein
the main frame comprises a first and a second side member extending substantially along the longitudinal direction of the vehicle framework, and a first and a second cross-member extending substantially horizontally and perpendicular to the longitudinal direction of the vehicle framework, wherein
the main frame is formed by deforming a single blank.

2. The vehicle of claim 1, wherein the main frame is made by hot stamping.

3. The vehicle of claim 2, wherein the single blank comprises at least a first sub-blank joined to a second sub-blank such that the first sub-blank partially overlaps the second blank forming an overlapping region.

4. The vehicle of claim 3, wherein the overlapping region is located in a portion of the main frame configured to be connected to of the vehicle framework.

5. The vehicle of claim 3, wherein the first sub-blank extends onto the second sub-blank by a length of between 2 and 30 cm.

6. The vehicle of claim 1, wherein the single blank comprises a tailor welded blank comprising at least two sub-blanks joined edge-to-edge to each other.

7. The vehicle of claim 2, wherein at least a portion of the main frame is made of a steel having an ultimate tensile strength above 1500 MPa after a press-hardening process.

8. The vehicle of claim 1, wherein at least a portion of the main frame has a substantially U-shaped cross-section, wherein
the U-shape has a bottom wall, a first side wall, a second side wall, a first lateral flange projecting outwardly at an end of the first side wall and a second lateral flange projecting outwardly at an end of second side wall.

9. The vehicle of claim 1, wherein the side members comprise a central region between the fore end and the aft end and wherein the central region is configured to be connected to the battery assembly.

10. The vehicle of claim 1, wherein the side members are configured to be connected to front rails and rear rails of the vehicle framework at the fore end and the aft end, respectively.

11. The vehicle of claim 9, wherein each side member is configured to be connected to a lateral rocker of the vehicle framework.

12. The vehicle claim 1, wherein the main frame comprises a soft zone with lower yield strength and/or tensile strength than a remaining part of the main frame.

13. A method for manufacturing a component for a vehicle framework comprising a main frame,
the method comprising:
providing a single blank;
heating the single blank at least partially above an Ac3 austenization temperature; and press hardening the heated single blank to form the main frame, wherein
the main frame substantially defines a closed ring shape and being configured for receiving a battery assembly in a central free space formed within the closed ring shape, and the main frame comprising a first and a second side members extending substantially along the vehicle framework extending substantially horizontally and perpendicular to the longitudinal direction of the vehicle framework,
wherein at least a portion of the main frame has a substantially U-shaped cross-section,
the U-shape having a bottom wall, a first side wall, a second side wall, a first lateral flange projecting outwardly at an end of the first side wall and a second lateral flange projecting outwardly at an end of second side wall.

14. The method of claim 13, wherein the single blank comprises at least two sub-blanks and the method comprises joining the sub-blanks to each other prior to the press hardening.

15. The method of claim 14, wherein joining the sub-blanks includes forming one or more overlapping regions by partially overlapping two sub-blanks.

16. A component of a vehicle framework configured to be connected to a battery assembly,
the component comprising:
a main frame extending from a fore end to an aft end along a longitudinal direction of the vehicle framework, wherein
the main frame substantially defines a closed ring shape and is configured for receiving the battery assembly in a central free space of the closed ring shape, and wherein
the main frame comprises a first and a second side member extending substantially along the longitudinal direction of the vehicle framework, and a first and a second cross-member extending substantially horizontally and perpendicular to the longitudinal direction of the vehicle framework, wherein
the main frame is formed by deforming a single blank, and wherein
at least a portion of the main frame has a substantially U-shaped cross-section, wherein
the U-shape has a bottom wall, a first side wall, a second side wall, a first lateral flange projecting outwardly at an end of the first side wall and a second lateral flange projecting outwardly at an end of second side wall.

17. The component of claim 16, wherein the main frame is made by hot stamping.

18. The component of claim 17, wherein the single blank comprises at least a first sub-blank joined to a second sub-blank such that the first sub-blank partially overlaps the second blank forming an overlapping region.

19. The component of claim 18, wherein the overlapping region is located in a portion of the main frame configured to be connected to the vehicle framework

20. The component of claim 18, wherein the first sub-blank extends onto the second sub-blank by a length of at least 1 cm.
